(19) United States
(12) Patent Application Publication
(10) Pub. No.: US 2026/0300257 A1
(43) Pub. Date: Oct. 1, 2026

(54) Dual Formatting within Connected Data Platform

(71) Applicant: Fivetran Inc., Oakland, CA (US)

(72) Inventors: Coral Trivedi, Marshfield, MA (US); George Williams Fraser, Oakland, CA (US); Kamaljit Pati, Balasore, Odisha (IN); Ashok Borra, Vijayawada, Andhra Pradesh (IN); Subash Chandra Roul, Kasavanahalli, Bengaluru (IN)

(21) Appl. No.: 19/360,863

(22) Filed: Oct. 16, 2025

Related U.S. Application Data
(60) Provisional application No. 63/779,971, filed on Mar. 28, 2025.

(51) Int. Cl. G06F 16/23; G06F 16/21

(52) U.S. Cl. CPC G06F 16/2358; G06F 16/219

(57) ABSTRACT

A system may receive, from a data source, incoming data that indicates a modification made to data stored at the data source. During generation of a structured data file for the incoming data, the system records, as metadata for the first type of data source, a checkpoint representing a first version of the data at the data source. The system creates a snapshot of the modification in the incoming data and records recording, as metadata for the second type of data source, a location of the snapshot at the data lake to a catalog, which stores respective locations in the data lake of one or more snapshots each corresponding to a version of the data from the data source. Iin response to recording the location of the snapshot at the catalog, the system may provide access to the structured data file at the data lake.

### CROSS REFERENCE TO RELATED APPLICATION

This application claims the benefit of U.S. Provisional Application No. 63/779,971, filed Mar. 28, 2025, which is herein incorporated by reference in its entirety.

### TECHNICAL FIELD

The disclosure generally relates to the field of data management, and more particularly relates to data movement from data lakes of differing formats.

### BACKGROUND

Data lakes provide a centralized repository for storing vast amounts of raw data in its native format, supporting structured, semi-structured, and unstructured data. Two leading open-source table formats for data lake architecture are Delta Lake^{TM} and Apache Iceberg^{TM}. Delta Lake brings ACID (Atomicity, Consistency, Isolation, Durability) transaction compliance and robust schema enforcement to data lakes, primarily using the Parquet file format and a transaction log to record all changes. Apache Iceberg offers a more flexible approach, supporting multiple file formats (Parquet, ORC, Avro) and a three-tier metadata architecture that includes catalogs for efficient management of table metadata, schema evolution, and version control. Apache also offers ACID compliance. Both formats enable time travel and rollback capabilities, but Iceberg’s snapshot-based versioning and engine-agnostic design provide enhanced flexibility for large-scale analytics across diverse processing engines.

Despite their advanced features, conventional data movement tools face significant inefficiencies when working with both Delta Lake and Apache Iceberg. Traditional approaches often rely on append-only writes, which can lead to the accumulation of small files and increased metadata overhead, degrading performance. Merge operations typically require scanning and rewriting large volumes of data, resulting in high computational costs and latency. Furthermore, when systems only support one format or require on-the-fly file conversion, data may be processed multiple times, introducing additional latency and resource inefficiency—which is especially problematic at scale. These challenges highlight the need for improved interoperability and more efficient data management solutions in modern data lake environments.

### SUMMARY

Systems and methods are disclosed herein for creating optimized Parquet files that are pre-merged into data of a data lake while also simultaneously updating both Iceberg and Delta Lake metadata for the Parquet files. More particularly, a set of incoming data may include modifications and metadata for data stored at a data lake that the system synchronizes with a data lake. The system rewrites a Parquet file describing the set of incoming data at the data lake except for the latest modification or metadata in the data. The system may rewrite the Parquet file every time it moves data from the data lake to data lake. Though the system writes one or more Parquet files for a set of incoming data, the system also maintains metadata for both formats (e.g., Iceberg and Delta Lake) in parallel. Though a time delay may occur between the creation of the Parquet file and updating of the metadata, the system does not make the data stored in the Parquet file available at the data lake until a new version of the data goes into effect, which occurs when the system has finished updating the metadata for both formats. Thus, the system keeps the Iceberg and Delta Lake metadata in sync even after moving incoming data into the data lake.

This system offers several significant advantages over traditional approaches. In particular, by storing both Iceberg and Delta Lake metadata for synced data, the system may maintain a faithful representation of the data moved in from one or more data sources, such that a user can query the data lake to access data that is otherwise stored in Iceberg and Delta Lake formats at the data’s original data source. Further, by producing both the Iceberg and Delta Lake metadata at the same transaction as Parquet files, the system may move data more efficiently into the data lake for access by a user.

### BRIEF DESCRIPTION OF DRAWINGS

The disclosed embodiments have other advantages and features which will be more readily apparent from the detailed description, the appended claims, and the accompanying figures(or drawings). A brief introduction of the figures is below.

FIG. 1 illustrates an environment for a centralized data analysis system, in accordance with one or more embodiments.

FIG. 2 is a block diagram illustrating components of an example machine able to read instructions from a machine-readable medium and execute them in a processor (or controller), in accordance with one or more embodiments.

FIG. 3 is a flowchart of a method for providing access to a structured data file in a data lake, in accordance with one or more embodiments.

### DETAILED DESCRIPTION

The Figures(FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Overview

Data Lakes allow the storage of vast amounts of raw data in a central repository, in their unmodified, native format. These repositories can house structured, semi-structured, and unstructured data. Two popular systems utilized for data lake architecture are Delta Lake^{TM} and Apache Iceberg^{TM}. Delta Lake is a storage layer that brings ACID (atomicity, consistency, isolation, durability) transactions to Apache Spark^{TM} and big data workloads and allows users to make modifications to the data stored in the data lake while maintaining data reliability. Apache Iceberg is an open table format designed to improve data tables at a petabyte scale. Apache Iceberg ensures more efficient data lookups and better handling of schema evolution compared to traditional columnar storage formats.

A user’s choice between using Apache Iceberg or Delta Lake (or another storage format) typically depends on the specific requirements of their use case, the particular features offered by each structure format, and downstream query engine to be used. Delta Lake is well-integrated into a first ecosystem and offers strong support for ACID transactions. This guarantees data integrity by enforcing a series of properties which ensure that database transactions are processed reliably. Apache Iceberg is part of a second ecosystem and offers promising metadata handling capabilities which make it more efficient for working with very large tables and many small files. Both systems support the Parquet file format and provide an open table format for huge analytic datasets. However, Apache Iceberg also requires the use of a catalog, whereas Delta Lake may use a catalog but is not required to do so.

A catalog manages the datasets (or tables) in Apache Iceberg and is responsible for table creation, evolution, and maintaining various versions and metadata of the tables. Catalogs in Apache Iceberg provide table metadata by providing the location of (also referred to simply herein as locating) the metadata files that describe where the data files are, what the schema of the table is, as well as other relevant information. A catalog holds the root points for the table metadata.

Delta Lake does not implement a catalog like Apache Iceberg does. However, Delta Lake can be integrated with metastore catalogs, such that Delta Lake uses catalogs to manage and organize large datasets in a centralized manner. Similar to a catalog for Apache Iceberg, a Delta Lake catalog holds metadata about the datasets such as table definitions, table names, column names, data types, access privileges, and the location of the data files.

Delta Lake maintains a transaction log that includes the details of every change made to its stored data, including the additions, deletions, and the schema changes. This makes the data stored in Delta Lake to be version-controlled, which is extremely beneficial for maintaining data integrity and for implementing features like audit trails, rollbacks, and time-travel querying in a data lake architecture.

In Apache Iceberg, the concept of version control is implemented through maintaining snapshots of table data. Each operation that modifies table data produces a new snapshot. The snapshots are versioned and stored in a metadata file in the table. The metadata for each snapshot, as well as a history of these snapshots, is managed in a table of metadata, the top level of which is tracked via pointers in the catalog. Any particular snapshot in Apache Iceberg represents an immutable version of the table, pointing to manifest files that in turn point to the data files that are part of the snapshot. This means that once a snapshot is created, it never changes - it is immutable. Due to this snapshot mechanism, multiple versions of the table can coexist without duplicated storage of common data. This facilitates efficient time travel (e.g., querying data as it existed at a certain point in time), rollbacks, and fine-grained auditing.

Given the numerous differences between Apache Iceberg and Delta Lake, conventional data movement tools do not support both. Conventionally, when writing data from a source into a data lake, a system writes the incoming data append-only, meaning that the data being written is only "appended" to the end of current data in the data lake and existing records are not updated or deleted at the data lake. A merge operation or copy operation is then used to copy incoming data and merge the incoming data with custom data. This is very central processing unit (CPU) intensive because the system must scan all of the incoming data, scan all of the existing data in the data lake, figure out where keys (e.g., identifiers of data and relationships between data) overlap, and update the existing data with the incoming data. The system typically uses compute resources associated with the data lake to complete these actions, which is computationally expensive for the user.

Since conventional systems natively support only one of Apache Iceberg or Delta Lake, they must convert data stored in the other format at query time. As a result, the systems redundantly process the requested data, leading to inefficiencies and latency, which may be drastic for a large amount of data to be converted. The later conversion also adds latency for query engines that have to wait on the conversion for further processing.

The centralized data analysis system described herein is more computationally efficient than conventional data movement systems. For a data source of either type (e.g., Apache Iceberg or Delta Lake), the centralized data analysis system reads existing data associated with the data source at a destination data lake and merges the incoming data effectively in memory at the destination data lake as the centralized data analysis system writes the incoming data and updates the existing data at the destination data lake. This allows the centralized data analysis system to avoid the extra merge or copy operation that conventional systems use and prevents the use of premium computing resources of the destination data lake (e.g., of the user of the data) that would be needed by the conventional systems for updates.

The centralized data analysis system is configured to move data from data sources to data destinations (also referred to as destination data lakes herein). By providing fully managed data pipelines, the centralized data analysis system may handle the real-time extraction, transformation, and loading (ETL) of data from a variety of data sources into a destination data lake. The centralized data analysis system manages transformations in the destination data lake directly and maintains pipelines and adjusts to data source changes automatically, saving substantial data infrastructure maintenance and engineering time.

The centralized data analysis system is agnostic to the type of data warehouse that is a source of data input to the centralized data analysis system, such that the centralized data analysis system can support users that use multiple types of data lakes and related data lake environments. Types of data lakes include Delta Lake (henceforth referred to as “Delta”) or Apache Iceberg (henceforth referred to as “Iceberg”) and may include other structure formats, in some embodiments. The centralized data analysis system is enabled to ensure consistency in updates to data stored in a destination data lake for either type of source data lake such that dual functionality is maintained after data movement from source data lake to destination data lake.

### Data Movement System

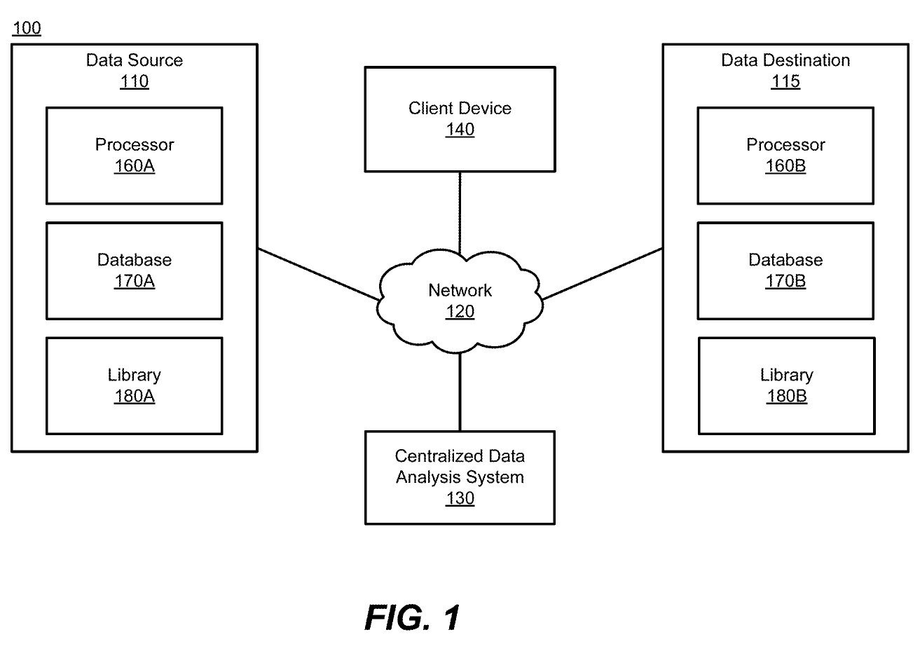

FIG. 1 illustrates an environment 100 for a centralized data analysis system 130, in accordance with one or more embodiments. As depicted in FIG. 1, environment 100 includes a data source 110, data destination 115, centralized data analysis system 130, and client device 140. In some embodiments, additional or alternative components to those shown in FIG. 1 may be included in the environment 100.

A data source 110 is an origin from which data is obtained for analysis, processing, or storage in systems like databases, data warehouses, or analytics platforms. Although FIG. 1 only shows one data source 110, any number of data sources 110 may be in communication with the centralized data analysis system 130. Data sources 110 may be broadly categorized into structured, semi-structured, and unstructured types. Structured data sources include relational databases (e.g., MySQL, PostgreSQL), enterprise resource planning (ERP) systems, and customer relationship management (CRM) tools, which organize data in defined formats like tables. Semi-structured sources include JSON or XML files from Application Programming Interfaces (APIs) or logs, while unstructured sources encompass formats like text documents, images, audio, and video files. Data sources 110 may reside on-premises or in the cloud (or distributed in part) and can include applications (e.g., Salesforce), file systems, streaming platforms (e.g., Kafka), or IoT devices.

A data destination 115 is a centralized repository designed to store and manage large volumes of structured data from data sources 110. Although only one data destination 115 is shown in FIG. 1, any number of data destinations 115 may be communicatively connected to the centralized data analysis system 130. Each data destination 115 may be any sort of data repository, such as a data warehouse or a data lake. Data destinations 115 may be built using specialized architectures that separate analytical processing from transactional systems. A key component is the Extract, Transform, Load (ETL) or Extract, Load, Transform (ELT) pipeline, which gathers data from disparate sources—such as CRM systems, ERP platforms, and operational databases—cleanses and transforms it, and loads it into the warehouse. This ensures data consistency, quality, and compatibility across different formats and systems. The data is then organized using dimensional models like star or snowflake schemas, which optimize it for querying by denormalizing tables and using fact and dimension tables to represent metrics and their contextual attributes.

Though described as a data source 110 and data destination 115 in FIG. 1, the data source 110 may perform the same functions as the data destination 115 and vice versa. For example, in some embodiments, the data destination 115 may receive data for storage from the data source 110 and also send data to a different data destination 115 for storage. In another example, the data source 110 may receive data from another data source 110 for storage.

Each of the data source 110 and data destination 115 may include a processor 160, database 170, and library 180. The data source’s 110 processor 160A gathers, prepares, and sends data. The processor 160A may from the database 170A, perform necessary computations or formatting, and ensure the data is ready for transmission. For example, the processor 160A may handle tasks like data extraction, filtering, transformation, and packaging, making sure the outgoing data meets the requirements of the data destination 115. The data destination’s 115 processor 160B receives, validates, and stories incoming data. When data arrives, the processor 160B checks its integrity and format, may transform the data to fit a schema, and directs the data into the database 170B. The processor 160B may also perform additional processing or analysis on the newly received data.

Each library 180 is a collection of reusable code modules or functions that help the data source 110 or data destination 115 perform specialized tasks. In some embodiments, one or both of the libraries 180 may be a dynamic linked library (DLL), which contains code and data that can be used by multiple components or processes at the same time. Thus, instead of a respective processor 160 including all the code the processor 160 needs within itself, the processor 160 can "link" to a DLL at runtime and use the functions, routines, or resources stored in that DLL. For example, when a request for data is received at the data source 110, the processor 160A may link to the library 180A to extract data from the database 170A, format the data according to a set of required specifications, and transmit the data to the data destination 115. In another example, the library 180B of the data destination 115 may include routines for validating format and integrity of received data, transforming the received data to match a schema of the database 170B, or handling errors that occur during data import. Each library 180 may inherit the permissions for its respective component – e.g., the library 180A of the data source 110 may inherit the permissions allocated to the data source 110 and the library 180B of the data destination 115 may inherit the permissions allocated to the data destination 115.

The components of FIG. 1 may be communicatively coupled via a network 120. The network 120 be any network suitable for facilitating communication between data sources 110, data destinations 115, client devices 140, and the centralized data analysis system 130. The network 120 may be any data communications channel, such as any combination of the Internet, Wi-Fi, short-range links, local area networks, and so on. The network tunneling may be used to connect any entity depicted in FIG. 1, such as virtual private network (VPN) or any other tunneling protocol.

A client device 140 is a computing system used by users to interact with the centralized data analysis system 130. A user interacts with the centralized data analysis system 130 using a client device 140 that executes client software, e.g., a web browser or a client application, to select data from data sources 110 to be stored in data destinations 115 and provide permissions to the centralized data analysis system 130 to access data at one or more data sources 110 or data destinations 115. The client device 140 displayed in these embodiments can include, for example, a mobile device (e.g., a laptop, a smart phone, or a tablet with operating systems such as Android or Apple IOS etc.), a desktop, a smart automobiles or other vehicles, wearable devices, a smart TV, and other network-capable devices.

The centralized data analysis system 130 may establish connectors between data sources 110 and data destinations 115. A connector is a software component that moves data from a data source 110 to a data destination 115 and is responsible for automating the transfer. The centralized data analysis system 130 may use the connector to authenticate the data source 110, connect to the data destination 115 via the network 120, and query the data source 110 to extract data for storage in the data destination 115. The centralized data analysis system 130 may also perform high volume sync operations between the data source 110 and data destination 115 and can be quickly instantiated using generative AI as described in Application No. 18/489,769, filed on Oct. 18, 2023, which is hereby incorporated by reference herein in its entirety. The centralized data analysis system 130 may further use the connector to track changes (e.g., inserts, updates, and deletes) made in the data source 110 and automatically update the data in the data destination 115 to correspond to the changes. The connector may not expose the additional port(s) required to be exposed for using an agent at a data source 110 to extract data.

The centralized data analysis system 130 is configured to move data from one or more data sources 110 to a data destination 115. In various embodiments, the data sources 110 and data destination 115 may each be a data lake or other type of data warehouse. The data destination 115 includes a plurality of Parquet files of data. Each Parquet file may represent a complete table for a dataset or a single table for a dataset may be partitioned across multiple Parquet files. Each Parquet file acts as a self-contained dataset that can represent either entire table of data or a portion of a larger table of data (e.g., a subset of the data). A Parquet file embeds schema with the data and stores data in a columnar layout, which enables efficient compression, metadata handling, and analytic query performance. Though the following description pertains to Parquet files, in some embodiments, the Parquet files may be files in any format of structured or unstructured data.

Along with Parquet files, a data destination 115 may store metadata that describes schema, partitioning, and version information for the Parquet files from one or more data sources 110 of varying types, as well as references to locations of the Parquet files. Such metadata enables the centralized data analysis system 130 to efficiently identify and access the Parquet files associated with a particular version of data from a data source 110. Though other types of data sources 110 may be used in other embodiments, the following description focuses on the use of Iceberg and Delta Lake for simplicity.

The data destination 115 may also include a catalog for Iceberg data that indicates what data is in each associated Parquet file, where to find data in Parquet files, what the version of data is in each Parquet file, and who has access to each Parquet file. For example, a catalog may indicate that the data destination 115 stores two tables – a first table with people’s names and a second table with people’s addresses, where each table is stored as a Parquet file. The catalog stores information that indicates to access the first table to find a name and to access the second table to find an address.

The centralized data analysis system 130 receives incoming data from data sources 110. In some embodiments, for a set of incoming data, the centralized data analysis system 130 may determine a type of the data source 110 (e.g., Iceberg, Delta Lake, etc.) that provided the set of incoming data. The centralized data analysis system 130 generates a Parquet file for the incoming data. Because Iceberg and Delta Lake organize metadata differently, the centralized data analysis system 130 updates data associated with both Iceberg and Delta Lake in the data destination 115 in the same transaction for the incoming data, regardless of whether the data source 110 is Iceberg, Delta Lake, or another type. For instance, the centralized data analysis system 130, in the same transaction that the Parquet file is being generated in, generates updated metadata for both Iceberg and Delta Lake formats based on the incoming data – e.g., by creating JavaScript Object Notation (JSON) files that point to the underlying Parquet file for the incoming data, in some embodiments.

The centralized data analysis system 130 also determines checkpoints and snapshots during generation of each Parquet file. For the Delta Lake metadata, the centralized data analysis system 130 records modifications to the data stored at the data destination 115 made based on the incoming data as transactions. The centralized data analysis system 130 may also generate checkpoints that represent a consistent snapshot of the state of the data at a point in time. The centralized data analysis system 130 may record a transaction log of the transactions and checkpoints such that the centralized data analysis system 130 may replay transactions made after a most recent checkpoint to reconstruct the current state of the data. In this way, the combination of checkpoints and transaction logs operates similarly to a database’s use of snapshots and write-ahead logs for efficient recovery and consistency.

Iceberg has a more elaborate scheme to manage versions compared to Delta Lake. For the Iceberg metadata, the centralized data analysis system 130 creates a snapshot for each modification to the data in the data destination 115 made based on the incoming data. A snapshot may be a metadata object that references the Parquet file(s) that make up a table of the data at a specific point in time. In some embodiments, the centralized data analysis system 130 tracks the snapshot with a metadata pointer in a catalog, such that the catalog includes version (e.g., state) information for the data. The metadata pointer for a snapshot may point to a corresponding metadata file and corresponding manifest lists in a metadata layer of the catalog and data files in a data layer of the catalog.

Each checkpoint and snapshot represent a version of the associated Parquet file (and table, in embodiments where the Parquet file is one of a set of Parquet files that comprise a table). The versions may be associated with a time that the version was created at the associated data source 110 or a time that the Parquet file associated with the version was created. The centralized data analysis system 130 may keep metadata describing the different versions in the catalog. The centralized data analysis system 130 writes both the Iceberg and Delta Lake metadata into the data destination 115 in the same transaction and updates a version associated with the data in the data destination 115 to correspond to the version of the incoming data upon committing the changes to the data destination 115. The new version of data only goes into effect (e.g., becomes available for access at the data destination 115) once the catalog for Iceberg is updated. In some embodiments, the new version of data only goes into effect once the centralized data analysis system 130 has finished storing transactions and checkpoint associated with the new version of the data.

Using the process described above, the centralized data analysis system 130 may create optimized Parquet files that are pre-merged into data of the data destination 115 while simultaneously updating both the Iceberg and Delta Lake metadata for the Parquet files. More particularly, the centralized data analysis system 130 rewrites Parquet files for all of the incoming data (e.g., modifications and metadata in the incoming data), except for the latest modification or metadata in the data, and does so every time the centralized data analysis system 130 moves data from a data source 110 to the data destination 115. Though a time delay may occur between the creation of a Parquet file and updating of the metadata, the centralized data analysis system 130 may not make the incoming data associated with a generated Parquet file available at the data destination 115 until a new version of the data goes into effect, which occurs when the centralized data analysis system 130 finishes fully updating the metadata of both types. The centralized data analysis system 130 may thus keep the Iceberg and Delta Lake metadata in sync even after moving incoming data into the data destination 115.

In some embodiments, during syncing of a new version of the data from a data source 110 to data destination 115 (e.g., updates, inserts, and deletes made to data from the previous version), the centralized data analysis system 130 may change the associated Parquet files and corresponding metadata at once before committing the transaction at the data destination 115. This optimizes access to the data available to users from the data destination 115 by ensuring that the users may see the newest version of the data regardless of whether the data source 110 was Delta, Iceberg, or another type.

By storing the synced Iceberg and Delta Lake metadata, the centralized data analysis system 130 may maintain a faithful representation of the data moved in from one or more data sources 110, such that a user can query the data destination 115 to access data that is otherwise stored in Iceberg and Delta Lake formats at the data’s original data source(s) 110. Further, by producing both the Iceberg and Delta Lake metadata in the same transaction as the Parquet files, the centralized data analysis system 130 moves data more efficiently into the data destination 115 for access by a user.

During synchronization of the data at the data destination 115, the centralized data analysis system 130 may also perform maintenance of the data stored at the data destination. Maintenance may include deleting data for old versions such that the data destination 115 only maintains a set number of versions of the data. This number may be provided by a user of the data destination 115 or an external operator. Maintenance may also include storing no more than a set number of Parquet files. In some embodiments, the centralized data analysis system 130 may use a range to determine how many Parquet files to keep, where the range is based on the size of the files. For instance, the centralized data analysis system 130 may maintain a larger number of Parquet files with a size below a threshold than the number of Parquet files with a size above the threshold. Compacting the number of Parquet files stored at the data destination 115 may improve the performance efficiency of queries to the data described in the Parquet files. For example, a large number of smaller files may be parsed more quickly than a small number of larger files, and this tradeoff may be represented in thresholds for size and number of the Parquet files maintained at the data destination 115. In some embodiments, the centralized data analysis system 130 may collect statistics related to queries performed using the Delta metadata and queries performed using the Iceberg metadata. The centralized data analysis system may use these statistics to dynamically determine a range of Parquet file sizes or number of Parquet files to maintain at the data destination 115 for optimal query processing.

During data synchronization, the centralized data analysis system 130 may also detect orphan files at the data destination 115. Orphan files are extraneous files stored at the data destination 115 with data that is not referenced in relation to the metadata, for either type, in the incoming data. Put another way, orphan files are “stray” Parquet files available at the data destination 115 that represent data that is no longer recognized in one or both of the Delta or Iceberg metadata. The centralized data analysis system 130 may remove orphan files that are not consistent with the metadata while also syncing data to the data destination 115.

The centralized data analysis system 130 may also perform optimized data sync operations. In doing so, the centralized data analysis system 130 may leverage the catalog for syncing metadata of both types, which the centralized data analysis system 130 may do in the same transaction. The catalog may provide an authoritative reference (e.g., “source of truth”) for metadata of the current version of data. During syncing of data from a data source 110 to data destination 115, the centralized data analysis system 130 may access the catalog and evaluate metadata in the catalog compared to metadata generated for the incoming data being synced. The centralized data analysis system 130 may determine what data has been updated or deleted based on the comparison. Rather than rewriting data for the catalog, the centralized data analysis system 130 may store data representing changes (e.g., updates and deletes).

### Computing Machine Architecture

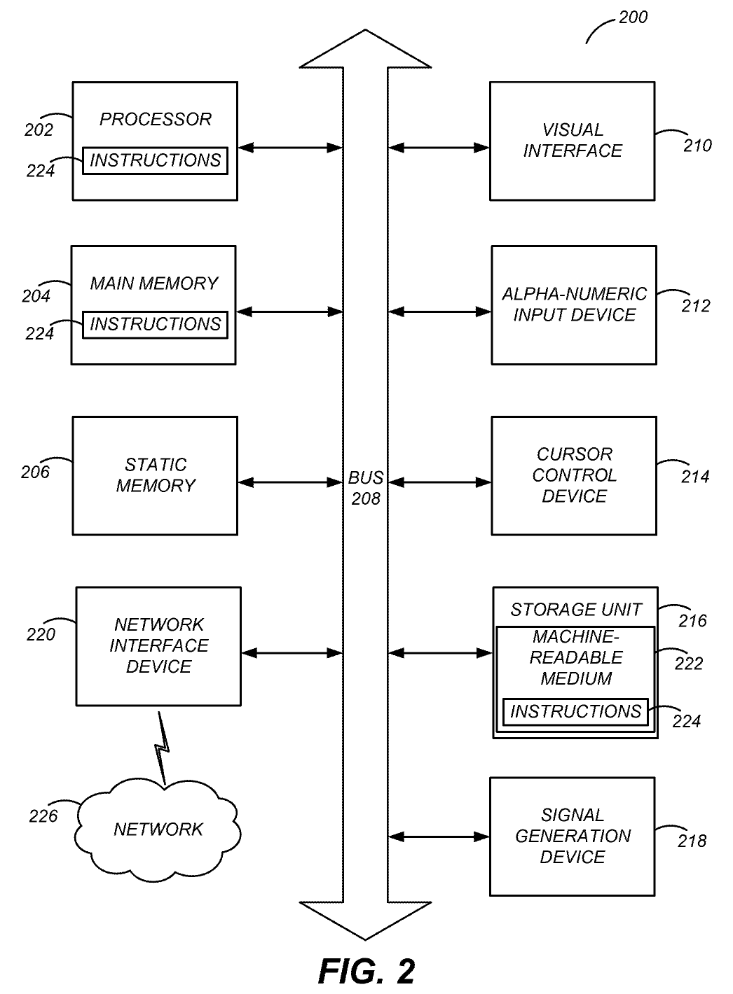

FIG. 2 is a block diagram illustrating components of an example machine able to read instructions from a machine-readable medium and execute them in a processor (or controller, or one or more of the same). Specifically, FIG. 2 shows a diagrammatic representation of a machine in the example form of a computer system 200 within which program code (e.g., software, including the modules described herein) for causing the machine to perform any one or more of the methodologies discussed herein may be executed. The program code may be comprised of instructions 224 executable by one or more processors 202. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 224 (sequential or otherwise) that specify actions to be taken by that machine. Further, while only a single machine is illustrated, the term “machine” shall also be taken to include any collection of machines that individually or jointly execute instructions 224 to perform any one or more of the methodologies discussed herein.

The example computer system 200 includes a processor 202 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 204, and a static memory 206, which are configured to communicate with each other via a bus 208. The computer system 200 may further include visual display interface 210. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 210 may include or may interface with a touch enabled screen. The computer system 200 may also include alphanumeric input device 212 (e.g., a keyboard or touch screen keyboard), a cursor control device 214 (e.g., a mouse, a trackball, a joystick, a motion sensor, or other pointing instrument), a storage unit 216, a signal generation device 218 (e.g., a speaker), and a network interface device 220, which also are configured to communicate via the bus 208.

The storage unit 216 includes a machine-readable medium 222 on which is stored instructions 224 (e.g., software) embodying any one or more of the methodologies or functions described herein. The instructions 224 (e.g., software) may also reside, completely or at least partially, within the main memory 204 or within the processor 202 (e.g., within a processor’s cache memory) during execution thereof by the computer system 200, the main memory 204 and the processor 202 also constituting machine-readable media. The instructions 224 (e.g., software) may be transmitted or received over a network 226 via the network interface device 220.

While machine-readable medium 222 is shown in an example embodiment to be a single medium, the term “machine-readable medium” should be taken to include a single medium or multiple media (e.g., a centralized or distributed database, or associated caches and servers) able to store instructions (e.g., instructions 224). The term “machine-readable medium” shall also be taken to include any medium that is capable of storing instructions (e.g., instructions 224) for execution by the machine and that cause the machine to perform any one or more of the methodologies disclosed herein. The term “machine-readable medium” includes, but not be limited to, data repositories in the form of solid-state memories, optical media, and magnetic media.

### Example Method

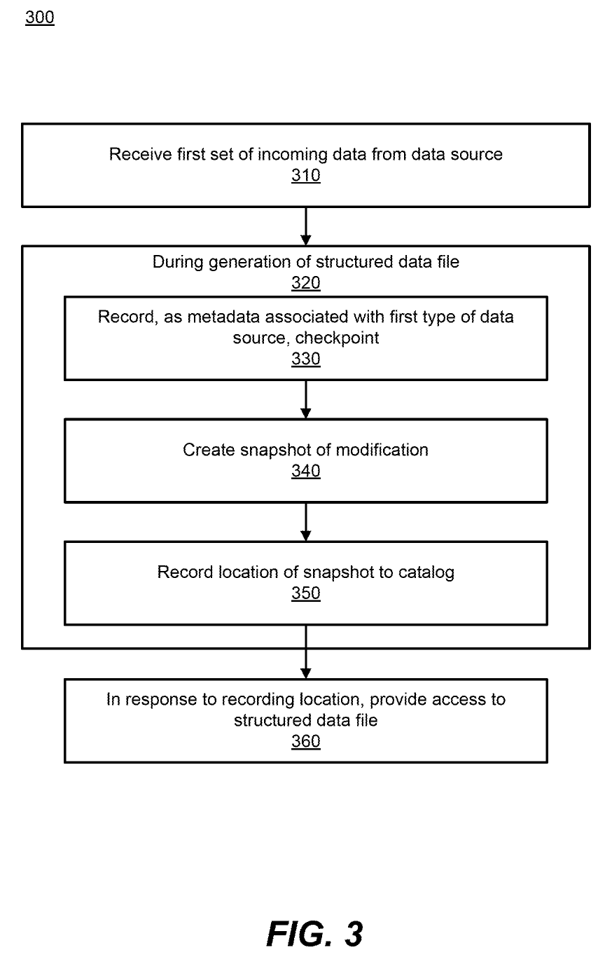

FIG. 3 is a flowchart of a method for providing access to a structured data file in a data lake, in accordance with one or more embodiments. In some embodiments, the method 300 includes additional or alternative steps or the steps may be performed by additional or alternative components to those described in relation to FIG. 3.

In some embodiments, the method 300 begins with receiving 310 a first set of incoming data from a data source 110, where the first set of incoming data indicates a modification made to data stored at the data source. The modification may be an update or delete. The data at the data source may be associated with a first version after the modification to the data was made. During generation of a structured data file 320, such as a Parquet file, for the first set of incoming data, the centralized data analysis system 130 may update metadata associated with a first type of data source and metadata associated with a second type of data source in the data destination 115 (referred to as a data lake in relation to FIG. 3). Particularly, the centralized data analysis system 130 may record 330, as metadata associated with the first type of data source, a checkpoint representing the first version of the data at the data source. The centralized data analysis system 130 may create 340 a snapshot of the modification in the incoming data. The centralized data analysis system 130 may record 350, as metadata associated with the second type of data source, a location of the snapshot at the data lake to a catalog, where the catalog stores respective locations in the data lake of one or more snapshots each corresponding to a version of the data from the data source. In response to recording the location of the snapshot at the catalog, the centralized data analysis system 130 may provide 360 access to the structured data file at the data lake.

In some embodiments, the metadata is recorded in a JavaScript Object Notation (JSON) file that includes pointers to other data structures that point to the structured data file. In some embodiments, the location of the snapshot is added to the catalog simultaneously to recording of the checkpoint. In some embodiments, the checkpoint includes a subset of a set of modifications made to the data at the data lake, where each modification in the subset is associated with a timestamp within a threshold amount of time from a current time and the subset of modifications includes the modification represented by the snapshot. In some embodiments, providing access to the structured data file at the data lake is further responsive to recording the checkpoint.

In some embodiments, the structured data file is generated at a first time and recording of metadata associated with the first type of data source occurs at a second time after the first time. In some embodiments, the structured data file is generated at a first time and recording of metadata associated with the second type of data source occurs at a second time after the first time. In some embodiments, the first type of data source is formatted for Delta Lake or the second type of data source is formatted for Iceberg. In some embodiments, the structured data file is a Parquet file.

In some embodiments, during generation of a structured data file for the first set of incoming data, the centralized data analysis system 130 performs maintenance of data stored at the data lake. For example, in some embodiments, the data lake stores a plurality of structured data files, where each structured data file is associated with a version of data at the data source. To perform maintenance of the data stored at the data lake, the centralized data analysis system 130 may determine whether a number of versions of the data stored at the data lake exceeds a threshold. In response to determining that the number of versions of data stored at the data lake exceeds the threshold, the centralized data analysis system 130 may determine a first subset of structured data files stored at the data lake. The first subset of structured data files may include a number of structured data files that is below the threshold, and each structured data file in the first subset may have been stored more recently at the data lake than remaining structured data files stored at the data lake. The centralized data analysis system 130 may remove the remaining structured data files from the data lake. In another example, in some embodiments, the centralized data analysis system 130 may perform maintenance of the data stored at the data lake by detecting an orphan file amongst a set of structured data files stored at the data lake. The orphan file may be not associated with metadata associated with the first type of data source and metadata associated with the second type of data source. The centralized data analysis system 130 may remove the orphan file from the data lake.

### Alternative Embodiments

The features and advantages described in the specification are not all inclusive and in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

It is to be understood that the figures and descriptions have been simplified to illustrate elements that are relevant for a clear understanding of the present invention, while eliminating, for the purpose of clarity, many other elements found in a typical online system. Those of ordinary skill in the art may recognize that other elements and/or steps are desirable and/or required in implementing the embodiments. However, because such elements and steps are well known in the art, and because they do not facilitate a better understanding of the embodiments, a discussion of such elements and steps is not provided herein. The disclosure herein is directed to all such variations and modifications to such elements and methods known to those skilled in the art.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the various embodiments. This description should be read to include one or at least one and the singular also includes the plural unless it is obvious that it is meant otherwise.

Upon reading this disclosure, those of skill in the art will appreciate still additional alternative designs for a unified communication interface providing various communication services. Thus, while particular embodiments and applications of the present disclosure have been illustrated and described, it is to be understood that the embodiments are not limited to the precise construction and components disclosed herein and that various modifications, changes and variations which will be apparent to those skilled in the art may be made in the arrangement, operation and details of the method and apparatus of the present disclosure disclosed herein without departing from the spirit and scope of the disclosure as defined in the appended claims.

What is claimed is:

1. A method for merging incoming data to a data lake, the method comprising:
receiving a set of incoming data from a data source, wherein the set of incoming data indicates a modification made to data stored at the data source, wherein the data at the data source is associated with a first version after the modification to the data was made;
during generation of a structured data file for the set of incoming data, updating metadata associated with a first type of data source and metadata associated with a second type of data source in the data lake by:
recording, as metadata associated with the first type of data lake, a checkpoint representing the first version of the data at the data source;
creating a snapshot of the modification in the set of incoming data;
recording, as metadata associated with the second type of data source, a location of the snapshot at the data lake to a catalog, wherein the catalog stores respective locations in the data lake of one or more snapshots each corresponding to a version of the data from the data source; and
in response to recording the location of the snapshot at the catalog, providing access to the structured data file at the data lake.

2. The method of claim 1, wherein the metadata is recorded in a JavaScript Object Notation (JSON) file that includes a pointer to the structured data file.

3. The method of claim 1, wherein the location of the snapshot is added to the catalog simultaneously to recording of the checkpoint.

4. The method of claim 1, wherein the checkpoint comprises a subset of a set of modifications made to the data at the data lake, each modification in the subset associated with a timestamp within a threshold amount of time from a current time, the subset of the set of modifications including the modification represented by the snapshot.

5. The method of claim 1, wherein providing access to the structured data file at the data lake is further responsive to recording the checkpoint.

6. The method of claim 1, wherein the structured data file is generated at a first time and recording of metadata associated with the first type of data source occurs at a second time after the first time.

7. The method of claim 1, wherein the structured data file is generated at a first time and recording of metadata associated with the second type of data source occurs at a second time after the first time.

8. The method of claim 1, wherein the first type of data source is formatted for Delta Lake.

9. The method of claim 1, wherein the second type of data source is formatted for Iceberg.

10. The method of claim 1, wherein the structured data file is a Parquet file.

11. The method of claim 1, further comprising:
during generation of a structured data file for the set of incoming data, performing maintenance of data stored at the data lake.

12. The method of claim 11, wherein the data lake stores a plurality of structured data files, each structured data file associated with a version of data at the data source, wherein performing maintenance of the data stored at the data lake comprises:
determining whether a number of versions of the data stored at the data lake exceeds a threshold; and
in response to determining that the number of versions of data stored at the data lake exceeds the threshold:
determining a first subset of structured data files stored at the data lake, wherein the first subset of structured data files includes a number of structured data files that is below the threshold, wherein each structured data file in the first subset was stored more recently at the data lake than remaining structured data files stored at the data lake; and
removing the remaining structured data files from the data lake.

13. The method of claim 11, wherein performing maintenance of the data stored at the data lake comprises:
detecting an orphan file amongst a set of structured data files stored at the data lake, wherein the orphan file is not associated with metadata associated with the first type of data source and metadata associated with the second type of data source; and
removing the orphan file from the data lake.

14. The method of claim 1, wherein the modification is an update or delete.

15. A non-transitory computer-readable storage medium storing instructions that, when executed, cause a processor to perform steps comprising:
receiving a set of incoming data from a data source, wherein the set of incoming data indicates a modification made to data stored at the data source, wherein the data at the data source is associated with a first version after the modification to the data was made;
during generation of a structured data file for the set of incoming data, updating metadata associated with a first type of data source and metadata associated with a second type of data source in a data lake by:
recording, as metadata associated with the first type of data source, a checkpoint representing the first version of the data at the data source;
creating a snapshot of the modification in the set of incoming data;
recording, as metadata associated with the second type of data source, a location of the snapshot at the data lake to a catalog, wherein the catalog stores respective locations in the data lake of one or more snapshots each corresponding to a version of the data from the data source; and
in response to recording the location of the snapshot at the catalog, providing access to the structured data file at the data lake.

16. The non-transitory computer-readable storage medium of claim 15, the steps further comprising:
during generation of a structured data file for the set of incoming data, performing maintenance of data stored at the data lake.

17. The non-transitory computer-readable storage medium of claim 16, wherein the data lake stores a plurality of structured data files, each structured data file associated with a version of data at the data source, wherein performing maintenance of the data stored at the data lake comprises:
determining whether a number of versions of the data stored at the data lake exceeds a threshold; and
in response to determining that the number of versions of data stored at the data lake exceeds the threshold:
determining a first subset of structured data files stored at the data lake, wherein the first subset of structured data files includes a number of structured data files that is below the threshold, wherein each structured data file in the first subset was stored more recently at the data lake than remaining structured data files stored at the data lake; and
removing the remaining structured data files from the data lake.

18. The non-transitory computer-readable storage medium of claim 16, wherein performing maintenance of the data stored at the data lake comprises:
detecting an orphan file amongst a set of structured data files stored at the data lake, wherein the orphan file is not associated with metadata associated with the first type of data source and metadata associated with the second type of data source; and
removing the orphan file from the data lake.

19. A system comprising:
a processor; and
a non-transitory computer-readable storage medium storing instructions that, when executed, cause the processor to perform steps comprising:
receiving a set of incoming data from a data source, wherein the set of incoming data indicates a modification made to data stored at the data source, wherein the data at the data source is associated with a first version after the modification to the data was made;
during generation of a structured data file for the set of incoming data, updating metadata associated with a first type of data source and metadata associated with a second type of data source in a data lake by:
recording, as metadata associated with the first type of data source, a checkpoint representing the first version of the data at the data source;
creating a snapshot of the modification in the set of incoming data;
recording, as metadata associated with the second type of data source, a location of the snapshot at the data lake to a catalog, wherein the catalog stores respective locations in the data lake of one or more snapshots each corresponding to a version of the data from the data source; and
in response to recording the location of the snapshot at the catalog, providing access to the structured data file at the data lake.

20. The system of claim 19, the steps further comprising:
during generation of a structured data file for the set of incoming data, performing maintenance of data stored at the data lake.
